(19) United States
(12) Patent Application Publication
(10) Pub. No.: US 2004/0138593 A1
(43) Pub. Date: Jul. 15, 2004

(54) Vestibular stimulation apparatus and method

(76) Inventor: Kevin Maher, Colorado Springs, CO (US)

Correspondence Address: HANES & SCHUTZ, P.C., 102 S. TEJON ST., SUITE 800, COLORADO SPRINGS, CO, 80903, US

(21) Appl. No.: 10/696,822

(22) Filed: Oct. 30, 2003

Related U.S. Application Data
(60) Provisional application No. 60/439,269, filed on Jan. 10, 2003.

(51) Int. Cl. A61H 1/00

(52) U.S. Cl. 601/1; 601/84; 601/112

(57) ABSTRACT

Apparatus and method for producing therapeutic vestibular stimulation in a patient, structurally comprising a platform for supporting a human body with body restraints attached to the platform, a pair of mutually parallel and coaxially disposed wheels respectively attached to the opposing sides of the platform, where the axis of the wheels defines a center of rotation of the platform and where rotation of the platform about its lateral axis of rotation simulates in the patient either a somersaulting or logrolling type of body activity.

This application claims the benefit under 35 U.S.C. §119(e) of a provisional application Serial No. 60/439,269, filed on Jan. 19, 2003 by the same inventor as the instant application and entitled Vestibular Roller and Tumbler.

The present invention relates to apparatus for therapeutic stimulation of the vestibular receptors located in the human inner ear and in related sensory integration systems within the human brain.

### BACKGROUND

Studies have shown that stimulation of the vestibular apparatus in a patient's inner ear is beneficial in the treatment of qualitative motor and sensory integration disorders caused by damage to the central nervous system in conditions such as, but not limited to, cerebral palsy, downs syndrome, autism, stroke and surgical procedures. Children and adults with these disabilities may have a dysfunctional sensory system where one or more senses are either over or under reactive to stimulation. Although the receptors for the senses are located in the peripheral nervous system it is believed that the problem inherent in these disorders stems from neurological dysfunction in the central nervous system, that is, the brain.

Sensory integration is an innate neurobiological process and refers to the integration and interpretation by the brain of sensory stimulation from the environment. In contrast, sensory integrative dysfunction is a disorder in which sensory input is not integrated or organized appropriately in the brain producing varying degrees of problems in development, information processing and behavior. Sensory integration focuses primarily on three basic senses—tactile, vestibular and proprioceptive. These three senses are not only interconnected but are also connected with other systems in the brain. They allow a person to experience, interpret, and respond to different stimuli in the environment. Treatment of basic sensory integrative processes is traditionally a function of physical or occupational therapy the goals of which are: (1) to provide the patient with sensory information which helps organize the central nervous system, (2) to assist the patient in inhibiting and/or modulating sensory information, and (3) to assist the patient in processing a more organized response to sensory stimuli.

The primary object of the present invention is to achieve these goals through treatment of nervous system dysfunctions that have at least some origin in the body's vestibular system. This system has several functions. It is most known for its function of maintaining balance and homeostasis, but because of its neurological connections, it plays important roles in posture, tone, coordination, vision and arousal. The primary structures of the vestibular system are located in the inner ear where, in each ear, there are three semicircular canals that are filled with fluid and hair cell receptors. Motion of the head creates movement of the fluid and the hairs within the semicircular canals, resulting in stimulation of the receptors. The vestibular receptors detect linear and angular acceleration imposed on the head, and thus provide signals to the central nervous system that indicate head position and the direction and velocity of head movements. By integrating vestibular inputs with signals from neck receptors, the central nervous system can differentiate head and whole-body movements and thus produce appropriate compensatory reflexes.

Movement of the head in space and the resultant stimulation of the vestibular receptors has been found to be an effective treatment of deficits in the vestibular system. Spinning, rolling and tumbling the body, can create such therapeutic movement of the head. In some cases, repeated manually implemented somersaults and log rolls are prescribed to accomplish the required stimulation of the vestibular system. However, the problem with this kind of therapy, especially with the elderly or a disabled patient, is the significant amount of assistance that is normally required for the patient to adequately and safely perform these maneuvers, to say nothing of the time commitment that is necessary to accomplish an adequate number of these exercises.

Accordingly, an object of the present invention is to provide a method and implementing mechanical apparatus that will perform the required head movements in a non-chaotic and organized regime that is controlled by a single person who does not have to be a certified or qualified therapist. Prior art platforms have been previously developed for sensory integration therapy, but have been confined to producing vertical and horizontal acceleration to the head with much the same result as would be expected from sitting astride a trotting horse. Artificial tortoise shells, balls, barrels, crawl rolls, scooters and swings have also found use in vestibular stimulation therapy, but while these devices may yield limited results they do not produce the efficacious effect achieved by the method of the present invention, as implemented by the manually rotatable seat and bed platforms disclosed herein.

Prior U.S. patents that address vestibular stimulation as a therapeutic tool include No. 5,520,614, issued May 28, 1996 to McNamara et al. for Vestibular Motion Table and No. 6,314,324 B1 issued Nov. 6, 2001 to Lattner et al. for Vestibular Stimulation System and Method. Neither of the methods disclosed in these patents are similar to the method of the present invention nor can their apparatus achieve the beneficial results of the disclosed devices.

### SUMMARY OF THE INVENTION

Because vestibular stimulation can most beneficially be accomplished with two different types of head movement the platform of the present invention to which the patient is secured is of two different types. The first type of apparatus simulates somersault tumbling, that is, rotation of the head about the body's horizontal lateral axis. The second type simulates a logrolling type of body movement that results in head rotation about the cephalocaudal or longitudinal axis of the body.

Both types of apparatus include a platform for supporting the patient's body with restraining means for securing the body to the platform. The platform is supported for rotation, including at least one shaft defining an axis of rotation. At least one circular disk is attached to the platform where the plane of the disk is perpendicular to the longitudinal axis of the shaft and the center of the disk is coaxial with the longitudinal axis of the shaft. The first type of platform is preferably in the form of a chair for supporting the patient in a sitting position for obtaining tumbling or somersault type of head rotation. The second type of platform is preferably in the form of an elongated bed for supporting the patient in a supine position for rotation of the head about the body's longitudinal axis, sometimes referred to as log rolling motion. In the preferred embodiment of the invention, two mutually parallel spaced apart circular disks are attached to the respective lateral sides of the chair for enabling rotation of the chair by manually grasping the edges of one or both of the disks and spinning the chair. Similarly, two mutually parallel and spaced apart circular disks are attached to the respective head and foot ends of the elongated bed and act to enable rotation of the bed when one or both of the disks is rotated either manually or by a motor. The platforms may be selectively rotated either forward or backward and for any number of rotations at any desired speed to accomplish the sensory integration therapy that is prescribed by the therapist.

### DESCRIPTION OF THE DRAWINGS

FIG. 1 is a perspective view of the tumbler version of the rotating platform of the present invention with a human figure positioned in the chair shown in dashed lines.

FIG. 2 is a front view of the tumbler platform.

FIG. 3 is a side view of the tumbler platform.

FIG. 4 is a perspective view of the roller version of the rotating platform of the present invention with a human figure in the supine position shown in dashed lines.

FIG. 5 is a side view of the roller version of the platform.

FIG. 6 is an end view of the roller version.

### DETAILED DESCRIPTION OF THE INVENTION

The therapeutic vestibular stimulation apparatus of the present invention is generally described as a rotatably mounted platform 2 for supporting a patient and having attached thereto a pair of mutually parallel spaced apart circular wheels or disks 4. Either or both of the wheels 4 may be grasped by a care giver at their circumferential edges and manually rotated or spun in order to impart the desired regimen of rotation and resultant vestibular stimulation to a patient that is seated or lying on the platform. In this specification the wheels 4 will be referred to as disks, however the wheels or disks 4 that are provided for imparting and enabling rotation to the platform could be only simple spoke members or arms extending radially from the center of rotation. The disks are preferred as the means for enabling rotation because the disks also serve as guards against the patient's arms and legs getting caught on the supporting structure or some other outside object during rotation. Depending on the direction of rotation imparted to the disks 4 the platform 2 may be spun forwardly or backwardly. The person manipulating the disks and enabling the rotation may control the rate and number of rotations.

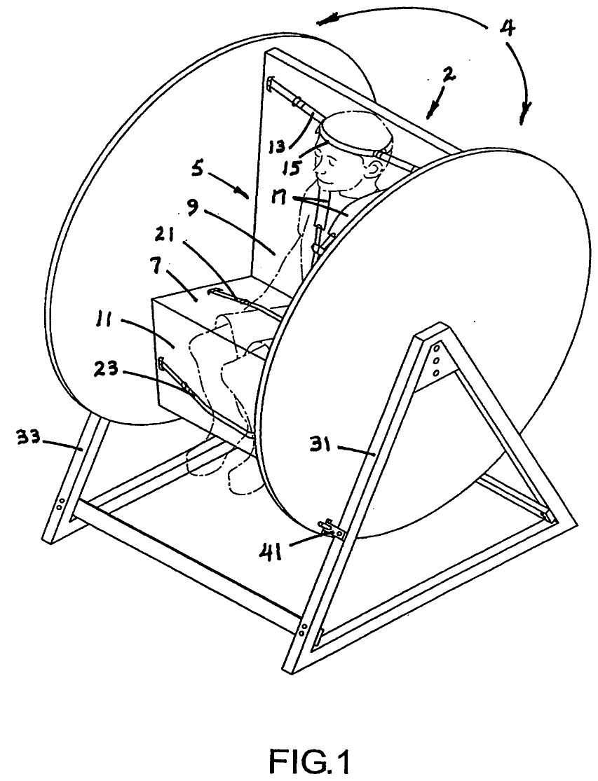

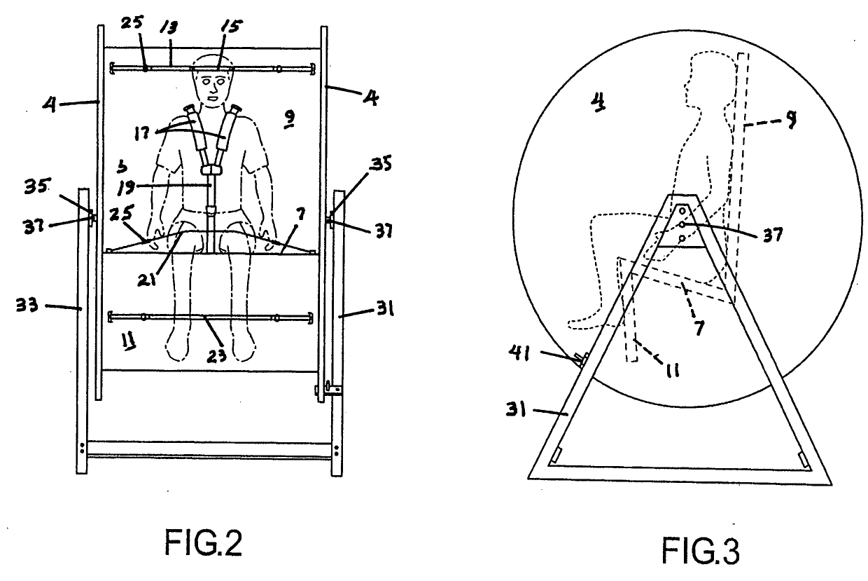

A preferred form of the tumbler species of the invention is shown in FIGS. 1, 2 and 3. The body-supporting platform 2 takes the form of a chair 5 having a seat 7, a back 9 and a front leg support 11. These components of the chair 5 are interconnected in any one of a number of ways that are known to persons skilled in the carpentry arts. The lateral sides of the chair 5 are attached to the inner planar surfaces of the disks 4. Attached to the chair back 9 is an adjustable restraining strap 13 that includes a circular band 15 for fitting around the head of the patient to maintain the head in a fixed position relative to the chair back. Secured to the chair back is a pair of shoulder straps 17 that merges into a single abdomen strap 19 that is fastened to the chair seat 7. The straps 17 and 19 function to restrain the body of the patient against movement relative to the seat and the back of the chair in a manner similar to that of the restraints in an infant's car seat. The thigh portions of the patient's legs are restrained against the seat 7 by an adjustable strap 21 whose ends are secured to the seat 7. The lower portions of the patient's legs are secured against the leg support surface 11 by a restraining strap 23 whose ends are fastened to the lateral portions of the leg support 11. All of the restraining straps are equipped with buckles 25 to enable the straps to be fastened into operative position and quickly removed to allow the patient to dismount from or be lifted off of the chair 5.

A pair of opposed frames 31 and 33 support the platform 2 and the disks 4. At the apex of each of the triangular frame members is a bearing 35 that journals a cantilevered shaft 37. The distal end of each of the respective shafts 37 is rigidly connected to the center of rotation of a respective one of the disks 4 to provide for free rotation of the disks 4 and the attached chair 5 when either of the disks 4 is rotated by manual manipulation. The preferred form of the invention contemplates manual control of the rotation of the disks 4 by a care-giver. However rotating the disks 4 with a motor and an associated computer program to control the sequence, speed and duration of the various elements of the platform's therapeutic maneuvers is within the skill of the art and is contemplated as a alternative embodiment of the invention.

A latch mechanism 41 selectively interconnects the outer side of one disk to one of the frame members 31 to lock the disks and chair into a stationary position for loading and unloading a patient or for storage of the apparatus.

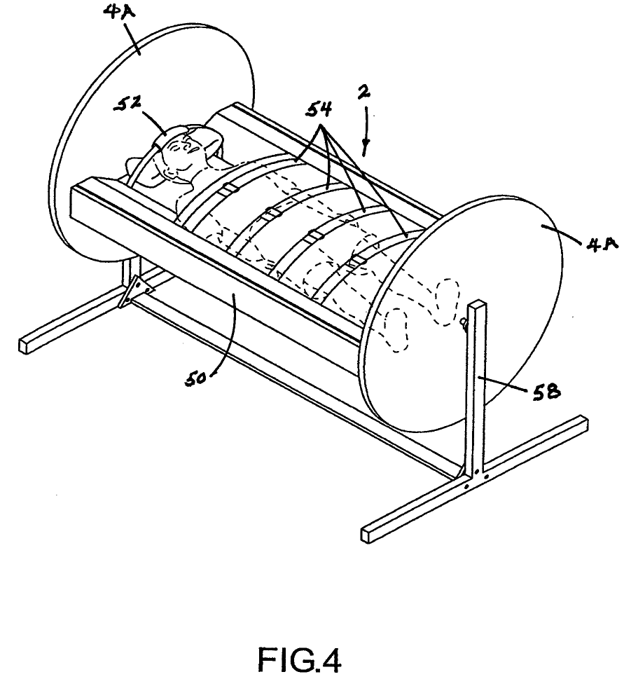

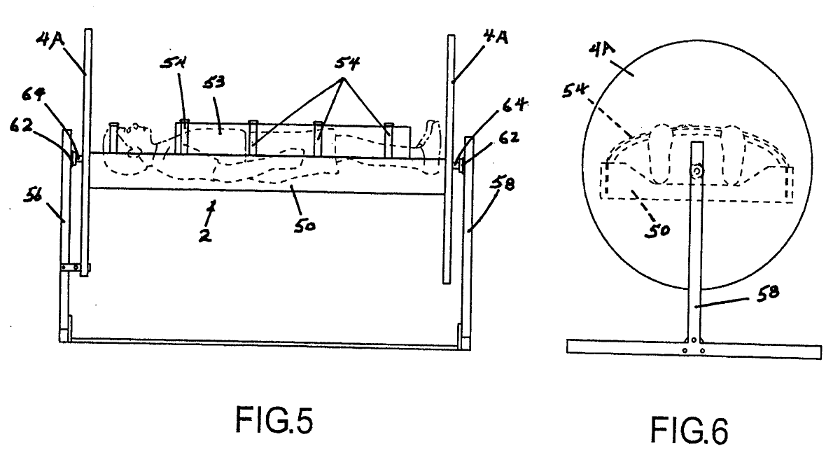

FIGS. 4, 5 and 6 illustrate the log rolling species of the invention. The platform 2 takes the form of a laterally contoured and longitudinally relatively flat bed 50 for supporting the patient in a supine position. A spaced apart pair of mutually parallel circular wheels or disks 4A is attached to the respective head and foot ends of the bed 50 for providing means to manually rotate the bed around its longitudinal axis. Such rotation provides vestibular stimulation around an axis that is perpendicular to the axis about which rotation is achieved in the tumbler species of the invention.

The patient is secured into the bed by a plurality of restraining straps. A selectively adjustable headband 52 is placed over the forehead of the patient to secure the head in a fixed position relative to the bed 50. Several selectively adjustable and longitudinally spaced apart body-securing straps 54 are positioned so as to adequately cover the torso and legs of the patient to secure the whole body into a fixed position relative to the bed 50. Preferably, a large pad 53 may be disposed between the body and the restraining straps 54 to equalize the pressure of the restraining straps on the patient's body.

Similar in function and purpose to the frame members 31 and 33 of the tumbler species of the invention, the rolling version is rotatably supported by vertical stands 56 and 58, positioned longitudinally outside of the disks 4A. Each of the stands is provided with a bearing 62 that journals a cantilevered shaft 64. The cantilevered distal end of each of the shafts 64 is attached to the center of rotation of the respective disks 4A for enabling rotation of the bed 50 about its longitudinal axis upon a manual rotation of either of the disks 4A. Similar to the tumbler species, the bed can be fitted for rotation by a programmed motor drive.

A latching mechanism 69 selectively interconnects one of the disks 4A with the supporting stand 56 to lock the bed in a fixed position for loading and unloading of the patient or for storage of the apparatus.

I claim:

1. Apparatus for producing therapeutic vestibular stimulation in a patient, comprising,
platform means having opposing sides for supporting a human body,
restraining means attached to the platform means for securing the body to the platform, and
means enabling rotation of the platform, including a pair of mutually parallel and coaxially disposed wheels respectively attached to the opposing sides of the platform, where the axis of the wheels defines a center of rotation of the platform.

2. The apparatus of claim 1 and further including,
at least one shaft rotatably supporting the platform and having a longitudinal axis coaxial with the wheels.

3. The apparatus of claim 2 where the wheels include at least one circular disk having a planar aspect and having a center, where the plane of the disk is perpendicular to the longitudinal axis of the at least one supporting shaft and the center of the disk is coaxial with the longitudinal axis of the at least one supporting shaft.

4. The apparatus of claim 1 where the platform means includes a chair having a back and a seat for supporting the human body in a sitting position.

5. The apparatus of claim 1 where the platform means comprises an elongated bed for supporting the body in a supine position.

6. The apparatus of claim 5 where the restraining means comprises,
a head restraining means,
longitudinally elongated padding means for covering the torso and limbs of the supine body,
a plurality of belts secured to the bed and selectively positioned laterally across the elongated padding for securing the padding against and restraining the supine body.

7. The apparatus of claim 4 where the restraining means comprises,
a head restraining band,
chest restraint means and a bifurcated shoulder band secured to the back of the chair,
a lap belt and leg restraining straps secured to the chair.

8. Apparatus for producing therapeutic vestibular stimulation in a patient, comprising,
platform means having opposing sides for supporting a human body,
restraining means attached to the platform means for securing the body to the platform,
axle means rotatably supporting the platform means and defining a center of rotation for the platform means,
means for imparting rotation to the platform means attached to at least one of the opposing sides of the platform means.

9. The apparatus of claim 8 where the means for imparting rotation to the platform means comprises at least one circular disk having a center and where the center is coaxial with the axle means.

10. The apparatus of claim 8 where the means for imparting rotation to the platform means comprises a pair of mutually parallel and spaced apart circular disks attached respectively to the opposing sides of the platform means.

11. The apparatus of claim 10 where the platform means includes a chair for supporting the human body in a sitting position and where the opposing sides comprise the lateral sides of the chair and where each respective one of the pair of circular disks is attached to the lateral sides of the chair.

12. The apparatus of claim 10 where the platform means includes an elongated bed for supporting the human body in a supine position and where the opposing sides comprise the head and foot of the elongated bed and where each respective one of the pair of circular disks is attached to the head and foot of the elongated bed.

13. A method for providing therapeutic vestibular stimulation in a patient, comprising the steps of;
securing the patient into a sitting position on a seat having a lateral axis of rotation,
rotating the seat about its lateral axis of rotation to simulate in the patient a somersaulting activity.

14. The method of claim 13 where the rotation is manually enabled.

15. A method for providing therapeutic vestibular stimulation in a patient, comprising the steps of;
securing the patient into a supine position on an elongated bed having a longitudinal axis of rotation,
rotating the bed about its longitudinal axis of rotation to simulate in the patient a rolling of the body about its cephalocaudal axis.

16. The method of claim 15 where the rotation is manually enabled.
